(19) United States
(12) Patent Application Publication
(10) Pub. No.: US 2017/0076441 A1
(43) Pub. Date: Mar. 16, 2017

(54) System and Method for Locating Errors in the Distribution of Prescribed Pills in an Organizer Box of Sequential Compartments Holding the Pills Therein

(71) Applicants: Teri Lynn Peterson, Austin, TX (US); Julius Bernard Kraft, Austin, TX (US)

(72) Inventors: Teri Lynn Peterson, Austin, TX (US); Julius Bernard Kraft, Austin, TX (US)

(21) Appl. No.: 14/850,172

(22) Filed: Sep. 10, 2015

(51) Int. Cl. G06T 7/00; A61J 7/00

(52) U.S. Cl. CPC G06T 7/0012; A61J 7/0084

(57) ABSTRACT

Enabling a user to determine whether any set of pills, stored in a physical sequential line of storage compartments with each of the sequential storage compartments having a respective set of pills, is the correct respective set of pills for the compartment.

### TECHNICAL FIELD

The present invention relates to the field of organizing prescribed pills in a pill organizer or box of sequential compartment each having deposited pills coinciding with a sequential time period at which the pills should be consumed.

### BACKGROUND OF PRIOR ART

The medical/pharmaceutical research over the past generation has extended the lives of people having access to good medical treatment. With discoveries increasing better health and longevity, has come a greatly increased use and consumption of prescribed pharmaceutical pills which have to be taken on a daily basis, This has imposed upon patients who are to consume such medication pills the great difficulty of keeping the daily set of pills accurately organized over a weekly or monthly basis.

These problems have been substantially increased when it is understood that the patients who are to take such pills are increasingly older. Understandably, with such aging have come decreased faculties of the patients who are required to accurately organize such pills. Even where there are health providers aiding such patients in pill organization, the time available from such health providers is usually very limited.

The potential for confusion in the organizing of pills to be sequentially taken is further greatly compounded by the financial necessity of increasingly prescribed generic drugs. Unfortunately, there still remains a complex legal situation with respect to generic drugs which results in most generic drugs having lengthy and complex names.

Many medical studies have indicated that the health and even the lives of patients have been jeopardized by errors on the part of patients and health providers in the organization of prescribed medication.

### SUMMARY OF THE INVENTION

The present invention provides for a computer controlled display method for enabling a user to determine whether any set of pills, stored in a physical sequential line of storage compartments with each of the sequential storage compartments having a respective set of pills, is the correct respective set of pills for the compartment. The visual image of each of a plurality of pills which could possibly be displayed is stored. An identifier for each of the plurality of pills to be physically stored in the sequential line of storage compartments is entered; and from the identifiers, there is generated a display image of the sequential line of compartments including the pills therein corresponding to said physical sequential line of storage compartments. This enables the user to visually compare the content, of any storage location in the physical sequential line of storage compartments to a corresponding visual image of the compartment so as to validate the content of the compartment.

This visual comparison expedient avoids the need for ill, old and impaired people to have to deal with several complex names of medication, pills, and particularly generic pills. As a result potential health and life-threatening errors, e.g. omissions or pill overdoses will be avoided.

In accordance with one aspect of the present invention, the visual image of the physical sequential line of storage compartments may be captured by a suitable camera or video camera associated with the display computer, and this captured image be used for a side by side visual compare on the computer controlled display. This compare may be done periodically and automatically.

Particularly when there an automatic comparison made, an alarm signal may be given whenever there is a failure to compare. This alarm signal may involve visually highlighting the sequential compartment in which there is a failure to compare. This highlighting may be in the displayed captured image of the physical compartment or in the visual image of correct content of the compartment. Alternatively, the only the image of the pill that fails to compare may be highlighted.

In an application of the present invention, each of the compartments in the physical sequential line of storage compartments includes the set of pills which should be consumed at a current time period, and the need for prescription of pills at a future time period may be indicated by a compare failure for a storage compartment including the set of pills to be consumed at said future time period. This will indicate that the prescription has run out and should be refilled.

Where the provider of the medication pills is controlling the pill distribution, that provider carries out said compare step; and in response to a failure to compare, supplies pills necessary to correct the failure.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of a prescribed medication pill distribution and tracking system in accordance with the present invention;

FIG. 2 shows another aspect of the tracking and distribution system of FIG. 1, wherein tracking and control is carried out by the medication pill provider;

FIG. 3 is a more specific variation of a portion of the system of FIG. 2, wherein a handheld display computer video scans the users organizer box;

FIG. 4 is an illustrative flow chart describing the setting up of the present process for distribution and tracking of prescribed medication pills;

FIG. 5 is a flow chart of an illustrative run of the process set up in FIG. 4;

FIG. 6 is a block diagram of a generalized display computer system adapted for the present invention

### DETAILED DESCRIPTION OF THE PREFERRED EMBODIMENT

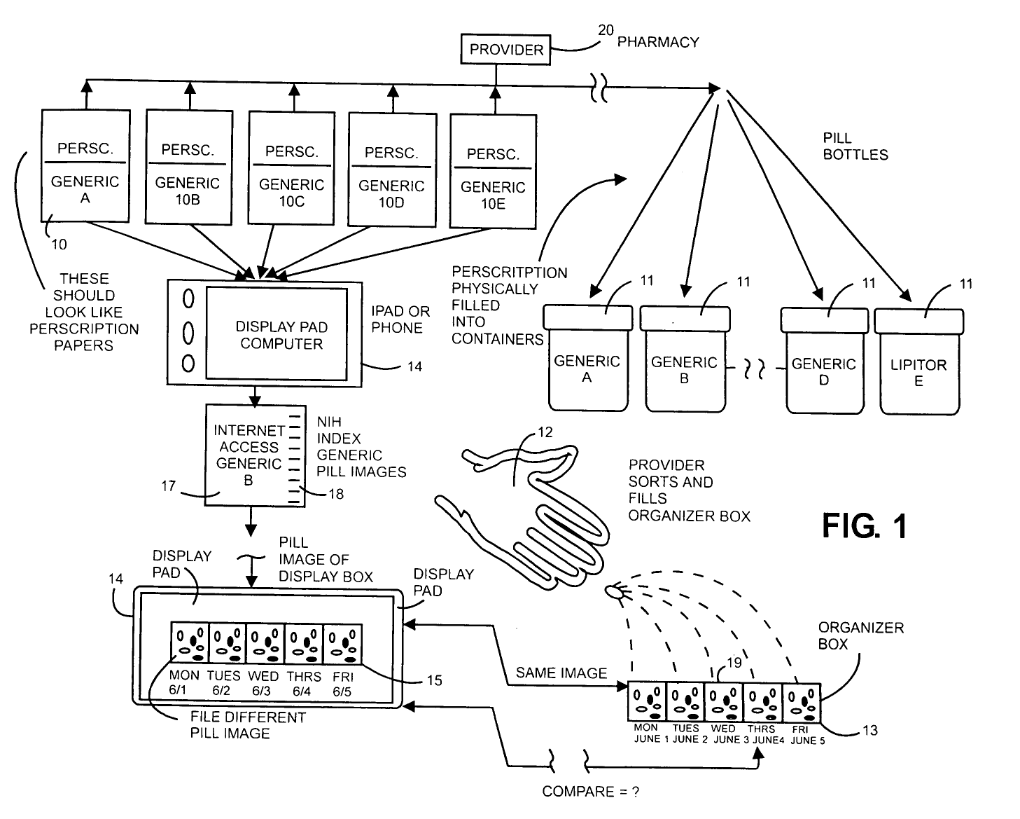

Referring to FIG. 1 simplified diagrammatic version of the present invention. The system shown illustrates a visual implementation expedient which avoids the need for ill, old and impaired people to have to deal with several complex names of medication pills, and particularly generic pills. As a result potential health and life-threatening errors, e.g. omissions or pill overdoses will be avoided. As will be hereinafter described, in locating errors in pill distribution and in correcting errors, the user will never have deal with the complex names of medication pills. Irrespective of whether the error handling is a manual visual comparison or an auto compare and correction by the system, the complex nomenclature will be transparent to the user. Provider 20, e.g. the local pharmacy provides the variety of prescribed pill to be consumed by the user on a regular daily or sequential basis. The provider 20 as well as the user who is consuming the pills have access to a display pad or conveniently a hand held device such as a display phone 14 possessed by the pill user. When several drugs are prescribed to the user, prescriptions, 10A, 10B, 10C, 10D, and 10E (for this illustration, prescriptions 10A-10D are for generic drug pills, and 10D is for name brand, e.g. Lipitor). In accordance will the process, all of the prescription data is also sent to display pad 14.

The provider also conventionally manually fills the prescriptions into conventional prescription bottles or containers 11A through HE with each respectively corresponding to prescriptions 10A-10E. For the purposes of this simplified illustration, the sequence of pills to be consumed is organized in a conventional, pill box organizer 13 of sequential compartments containing the pills to be taken on each respective sequential day, e.g. from Monday, June 1 through Friday, June 5. These organizer boxes usually have weekly, biweekly, or even monthly sequences of compartments. The user or his health assistant, manually 12 loads the compartments of the organizer box 13 with appropriate pills from pill bottles 11A-E, The sets of pills in compartments 19 of the organizer are visible to the user because any compartment covers in the organizer 13 should be transparent. Should the covers not be transparent, they will be opened for any comparisons which will be described hereinafter, The sets of pills in any or all of the sequential compartments in the organizer 13 may now be visually compared to a visual image 15 displayed on display computer 14 of correct sets of pills which should be in the respective sequential compartments.

The visual image 15 of organizer box 13 is generated as follows. A visual replica of the outline of organizer box 13 is formed in displayer computer 14. Then as each prescriptions 10A-E in filled by the pharmacy provider, the provider transmits the prescription information to display computer 14. Thus, there is displayed an exact image of each prescribed pill and its location in each sequential compartment of displayed visual image 15 of organizer 14. The exact image of each pill is determined in the user's display computer by accessing 17 through Internet available registers such as the NIH Index 18 of all dispensed pills in the Pharmacopeia. This includes all generic brand pills, wherein the generic of a given composition may have several images, dependent upon the suppliers. Accordingly, this invention avoids the user or the user's health worker from having to deal with the confusingly complex generic names. Because the comparison of images and not names of pills, the process is completely transparent to generic names, the utterly unfair and dangerous need for patient and provider to wrestle with the complexity of generic nomenclature is bypassed.

The visual comparison of this invention may advantageously be used whenever the organizer box is filled with new prescriptions. Also, if a handicapped, slow or otherwise limited user spills some of the pills from their compartments, and must then organize the pills in their respective compartments, the user need not consult the complex pill names from the prescription pill bottles. In such organization of pills, the user just deals with the images of the pills, and can remain completely unaware of the pill names.

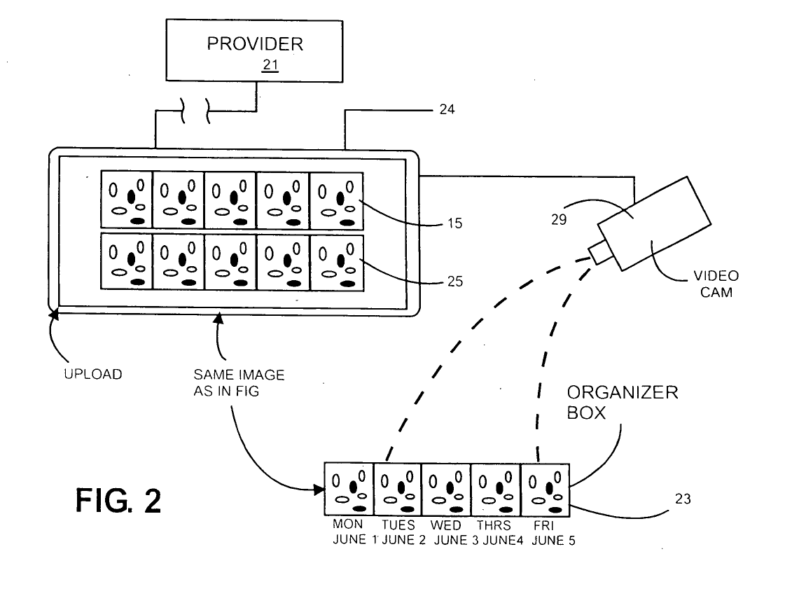

In accordance with another aspect of the invention, in a modification of the organization of FIG. 1, a video camera 29, FIG. 2 directly captures the image of the physical organizer box 23. The captured image 25 is displayed alongside of the previously described (FIG. 1) image 15 on computer display 24. The user may then check to compare any or all compartments in the captured physical 25 image to the visual image 15 of what should be in each compartment.

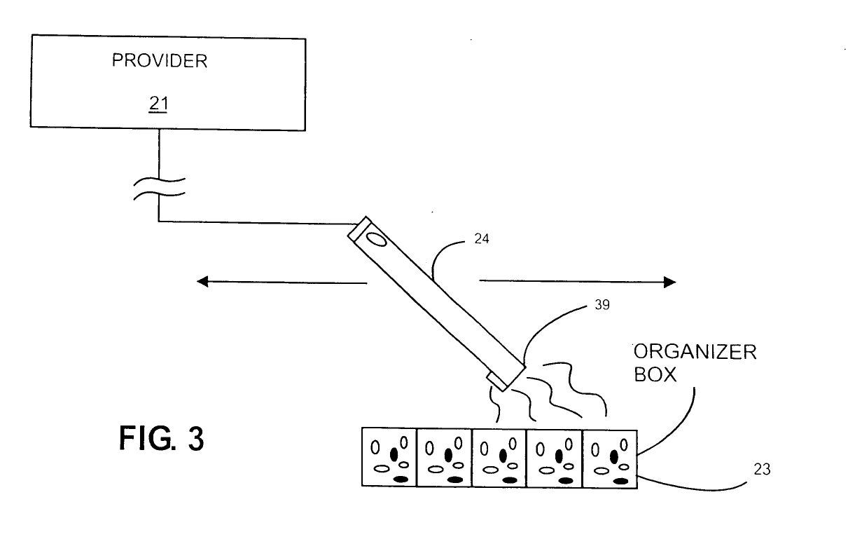

The system may be set up with an appropriate alarm to catch the user's attention to any compartment which fails to compare. Also, the compartment which fails to compare may be highlighted. In a more particular aspect of the invention of FIG. 2, there may be even greater involvement in distribution and monitoring by pharmacy provider 21 as shown in FIG. 3. The provider will have control of the user's display computer 24, and the standard photo/video camera 39 will be scanned across the physical organizer box 23.

Whenever a user is sequentially consuming several pills in each time period, it is reasonable to have one pharmacy provider to distribute and monitor pill usage. This avoids contra-indications by combinations of different pills. Thus, the present invention would be an extension of pharmacy provider control. Actually, there is an economic advantage to the provider to give the pharmacy customers a dedicated simplified display computer 24 adapted to only carry out the functions of this invention. Such dedicated display computers are relatively inexpensive to produce. The pharmacies would be assured of relatively dedicated customers, it would be preferable if the organizer 23 were of such dimensions as to be operatively associated with the display computer. If there are any problem in the scanning the organizer boxes because of a great many pills in each compartment, the organizer box could a structure in which both the top and bottom of each compartment would be transparent, Then, the computer display's cam could scan both top and bottom of the organizer box. The two scans should be able to capture at least a partial image of every pill in any compartment. With present art recognition techniques, pill images would be recognized even if a small part of a pill would be exposed.

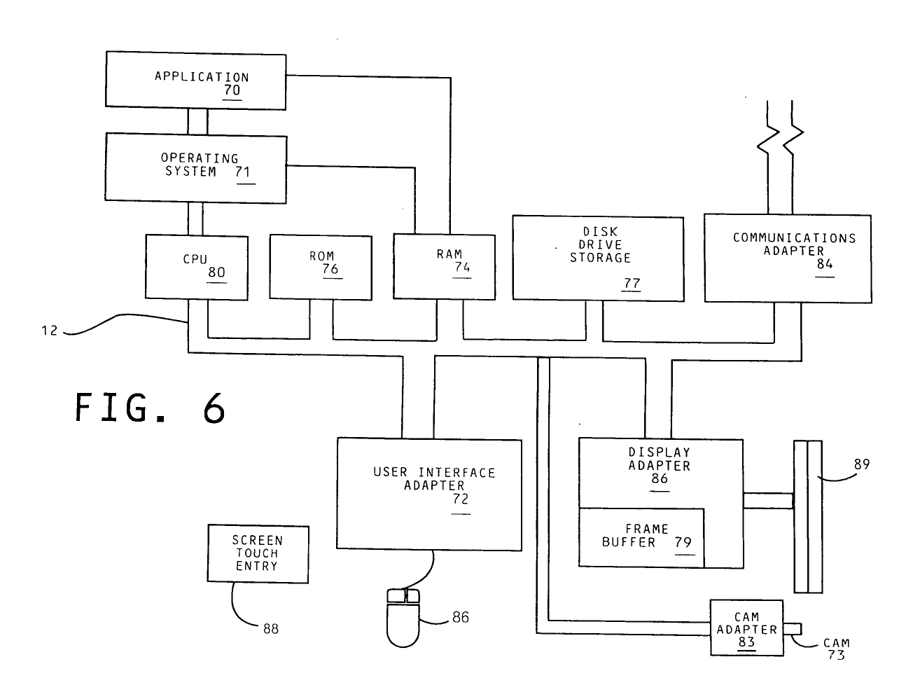

The processes described herein are implemented on a computer controlled display device 14, FIG. 1. There is shown, in FIG. 6, a block diagram of a data processing system including a central processor 80 which is in the computer controlled display. The central processor is interconnected to various other components by system bus 12. An operating system 71 runs on processor 80, provides control and is used to coordinate the functions of the various components of FIG. 6. The programs used in the present invention are moved into and out of the main memory Random Access Memory (RAM) 74. These programming applications are be used to implement functions of the present invention, Read Only Memory (ROM) 76 includes the Basic Input/output System (BIOS) that controls the basic computer functions of the computer controlled display, RAM 74, ROM 76, processor 80 are also interconnected to system bus 82, User entry via mouse 86 and screen touch 88 are also connected via an appropriate user interface adapter 72. The video camera 73 is connected to bus 82 through an appropriate camera adapter 83. Display 89 is controlled through display adapter 86 including frame buffer 79. Communications adapter 84 enables network communication with controlling pharmacy provider. Most computer controlled display devices include some disk drive storage 77. However, if the computer controlled display is a simple specific purpose display, as could be made available by the pharmacy provider, a ROM such as any EPROM could provide sufficient storage memory that the disk drive storage could be eliminated.

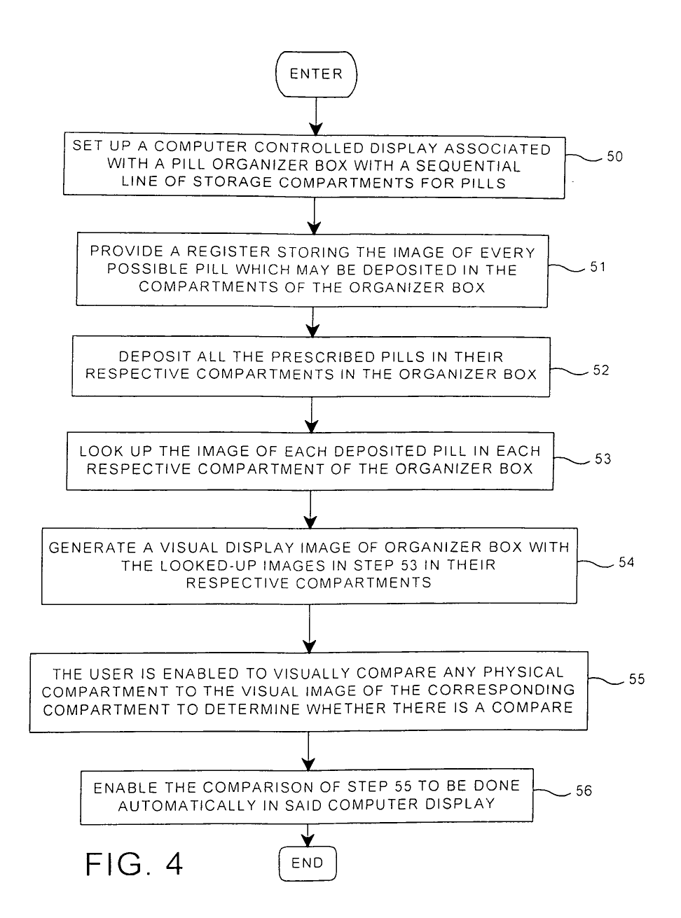

FIG. 4 is a general flowchart of a program set up to implement the present invention for enabling a user to determine whether the pills in the compartments in a sequential organizer are correct. A computer controlled display is set up in association with a pill organizer box having a sequential line of storage compartments for hold pills to be sequentially consumed, step 50. A standard register is provided which stores the image of every possible pill, currently being prescribed, which may be deposited in the compartments of the pill organizer box, step 51. Provision is made for the deposit of all of the prescribed pills in their respective compartments in the organizer box, step 52. Provision is made for enabling the user to look up the register image of each respective pill deposited in a compartment in the organizer box, step 53. Provision is made, step 54, for generating an image of the organizer box with the looked-up pill images of step 53 in the respective compartments.

Provision is made, step 55, for enabling the user to visually compare any physical compartment to the visual image of the corresponding compartment to determine whether there is a compare. Provision is made to have the comparison of step 55 to be done automatically, step 56.

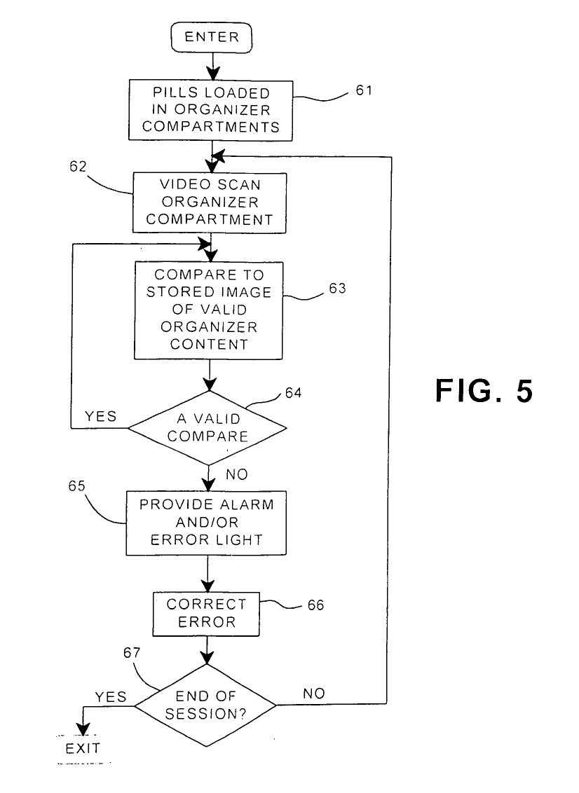

FIG. 5 is an illustrative run of the process set up in FIG. 4. The process is commenced when the pills of all of prescriptions are physically loaded into their respective compartments, step 61. A video camera scan of the organizer box is carried out, step 62. A comparison is done, step 63, of the scanned image of step 62 with the stored image gotten in step 54 of FIG. 4. A determination is made, step 64, of whether there is a valid compare. If Yes, the process is returned to step 63 for continued comparison. If No Compare, an appropriate error output is made, step 65, and whatever correction to be made is made, step 66. A periodic determination is then made, step 67, as to whether the current session is over. If Yes, the session is exited. If No, then the process is returned to step 62, wherein a further scan and compare may be continued.

Although certain preferred embodiments have been shown and described, it will be understood that many changes and modifications may be made therein without departing from the scope and intent of the appended claims.

For example, where the pharmacy provide has control of the distribution including, data as to which pills have to be in each respective compartment of the users organizer box, the following implementation may be done, The provider may look up the image of each pill in each compartment from the NIH register as described herein above then the pharmacy provider may generate a printed image of what the users organizer box compartments should look like for the purpose of a visual comparison.

What is claimed is:

1. A computer controlled display method for enabling a user to determine whether any set of pills, stored in a physical sequential line of storage compartments, wherein each of said sequential storage compartments has a respective set of pills, is the correct respective set of pills for the compartment comprising:
storing the visual image of each of a plurality of pills which may be displayed;
entering an identifier for each of the plurality of pills to be physically stored in said sequential line of storage compartments; and
generating, from the identifiers, a display image of said sequential line of compartments including the pills therein corresponding to said physical sequential line of storage compartments grid,
wherein said user is enabled to visually compare the content of any storage location in said physical sequential line of storage compartments to a corresponding visual image of the compartment to validate the content of the compartment,

2. The method of claim 1, further including:
capturing the visual image of said physical sequential line of storage compartments; and
using the captured image for said visually compare.

3. The method of claim 2 wherein said compare step is carried out automatically in said computer controlled display.

4. The method of claim 1, further including generating an alarm upon a compare failure.

5. The method of claim 4, further including highlighting at least one pill image in any visual sequential line of storage compartments upon a failure to compare.

6. The method of claim 5, wherein
each of compartments in said physical sequential line of storage compartments includes the set of pills which should be consumed at a current time period, and
the need for prescription of pills at a future time period may be indicated by a compare failure for a storage compartment including the set of pills to be consumed at said, future time period.

7. The method of claim 1 further including highlighting any displayed storage compartment at which there is a change of the pill content.

8. The method of claim 3, wherein
a provider that supplies the pills to be placed in said compartments carries out said compare step; and
in response to a failure to compare, supplies pills necessary to correct the failure.

9. The method of claim 1, wherein said computer controlled display is a specific purpose handheld display provided by said provider.

10. A computer controlled system for enabling a user to determine whether any set of pills, stored in a physical sequential line of storage compartments, wherein each of said sequential storage compartments has a respective set of pills, is the correct respective set of pills for the compartment comprising;
a processor; and
a computer memory holding computer program instructions which when executed by the processor perform the method comprising:
storing the visual image of each of a plurality of pills which may be displayed;
entering an identifier for each of the plurality of pills to be physically stored in said sequential line of storage compartments; and
generating, from the identifiers, a display image of said sequential line of compartments including the pills therein corresponding to said physical sequential line of storage compartments grid,
wherein said user is enabled to visually compare the content of any storage location in said physical sequential line of storage compartments to a corresponding visual image of the compartment to validate the content of the compartment.

11. The system of claim 10, wherein said method further includes:
capturing the visual image of said physical sequential line of storage compartments; and
using the captured image for said visually compare.

12. The system of claim 11 wherein said compare step in said method is carried out automatically in said computer controlled display.

13. The system claim 10, wherein said method further includes generating an alarm upon a compare failure,

14. The system of claim 13, wherein said method father includes highlighting at least one pill image in any visual sequential line of storage compartments upon a failure to compare.

15. The system of claim 14, wherein
each of compartments in said physical sequential line of storage compartments includes the set of pills which should be consumed at a current time period, and
the need for prescription of pills at a future time period may be indicated by a compare failure for a storage compartment including the set of pills to be consumed at said future time period.

16. The system of claim 10, wherein said method further includes highlighting any displayed storage compartment at which there is a change of the pill content.

17. The system of claim 12, wherein
a provider that supplies the pills to be placed in said compartments carries out said compare step; and
in response to a failure to compare, supplies pills necessary to correct the failure.

18. The system of claim 10, wherein said computer controlled display is a specific purpose handheld display provided by said provider.

19. A computer usable non-transitory storage medium having stored thereon a computer readable program for enabling a user to determine whether any set of pills, stored in a physical sequential line of storage compartments, wherein each of said sequential storage compartments has a respective set of pills, is the correct respective set of pills for the compartment, wherein the computer readable program when executed on a computer causes the computer to:
store the visual image of each of a plurality of pills which may be displayed;
enter an identifier for each of the plurality of pills to be physically stored in said sequential line of storage compartments; and
generate, from the identifiers, a display image of said sequential line of compartments including the pills therein corresponding to said physical sequential line of storage compartments grid,
wherein said user is enabled to visually compare the content of any storage location in said physical sequential line of storage compartments to a corresponding visual image of the compartment to validate the content of the compartment.

20. The computer usable non-transitory storage medium of claim 19, wherein the computer program when executed further causes the computer to:
capture the visual image of said physical sequential line of storage compartments; and
use the captured image for said visually compare.

21. The computer usable non-transitory storage medium of claim 20 wherein the computer program when executed said compare to be carried out automatically in said computer controlled display.

22. The computer usable storage medium of claim 20, wherein the computer program when executed further causes the computer to generate an alarm upon a compare failure.

23. The computer usable storage medium of claim 20, wherein the computer program when executed further causes the computer to highlight at least one pill image in any visual sequential line of storage compartments upon a failure to compare.

24. The computer usable storage medium of claim 23, wherein
each of compartments in said physical sequential line of storage compartments includes the set of pills which should be consumed at a current time period, and
the computer program when executed indicates the need for a prescription of pills at a future time period by a compare failure for a storage compartment including the set of pills to be consumed at said future time period.

25. The computer usable storage medium of claim 10, wherein the computer program when executed further causes the highlighting of any displayed storage compartment at which there is a change of the pill content.

26. A method for enabling a user to determine whether any set of pills, stored in a physical sequential line of storage compartments, wherein each of said sequential storage compartments has a respective set of pills, is the correct respective set of pills for the compartment comprising:
storing the image of each of a plurality of pills;
entering an identifier for each of the plurality of pills to be physically stored in said sequential line of storage compartments; and
generating, from the identifiers, an image of said sequential line of compartments including the pills therein corresponding to said physical sequential line of storage compartments;
wherein said user is enabled to visually compare the content of any storage location in said physical sequential line of storage compartments to a corresponding image of the compartment to validate the content of the compartment.
